(19) United States
(12) Patent Application Publication
(10) Pub. No.: US 2008/0119166 A1
(43) Pub. Date: May 22, 2008

(54) METHOD FOR SECURE TRANSMISSION OF THIRD PARTY CONTENT TO CDMA1X USER FOR BROADCAST AND MULTICAST SERVICES

(76) Inventor: HONGRU ZHU, Beijing (CN)

Correspondence Address: WILLIAMS, MORGAN & AMERSON, 10333 RICHMOND, SUITE 1100, HOUSTON, TX, 77042, US

(21) Appl. No.: 11/695,241

(22) Filed: Apr. 2, 2007

(30) Foreign Application Priority Data
Nov. 16, 2006 (CN) 200610064343.X

(51) Int. Cl. H04M 1/66

(52) U.S. Cl. 455/411

(57) ABSTRACT

The present invention provides a method involving a mobile shell, a removable user identity module communicatively coupled to the mobile shell, a home location register, and a broadcast/multicast controller. One embodiment of the method includes receiving, at the home location register, a first random number provided by the broadcast/multicast controller and forming, at the home location register, a registration key based on the first random number. The registration key is derivable by the user identity module based on a second random number derived from the first random number. The method also includes providing the registration key to the broadcast/multicast controller.

### CROSS REFERENCE TO RELATED APPLICATIONS

This patent application claims priority to the previously filed Chinese Application No. 200610064343.X which was filed with the Chinese Patent Office on Nov. 16, 2006.

### BACKGROUND OF THE INVENTION

1. Field of the Invention

This invention relates generally to communication systems, and, more particularly, to wireless communication systems.

2. Description of the Related Art

Wireless communication systems are rapidly evolving to include mobile networks that provide a wide variety of services to mobile units such as cellular telephones, personal data assistants, smart phones, text messaging devices, pagers, network interfaces, notebook computers, and desktop computers. For example, multimedia services such as mobile television may be provided using broadcast/multicast service (BCMCS) networks. Mobile networks like the BCMCS network typically provide security mechanisms to prevent unauthorized users from accessing information transmitted over the network. One conventional key hierarchy for broadcast/multicast security is based upon a registration key (RK) that is known by authorized users and a broadcast/multicast controller in the mobile network. Session keys (SK) for encrypting and decrypting information broadcasted and/or multicasted by the mobile network can be derived from a broadcast access key (BAK) that the broadcast/multicast controller provides to the user. Before being provided to the authorized users, the BAK is encrypted using a temporary key (TK) that the broadcast/multicast controller derives from the registration key. The BAK may be periodically refreshed, e.g., on a daily or weekly basis.

Content for the broadcast/multicast services is often provided by third parties who use the functionality of the mobile network to broadcast or multicast the provided content. The third-party typically encrypts multimedia content using one or more content keys to insure that only authorized users can decrypt the transmitted multimedia content. Some mobile networks implement a Generic Bootstrapping Architecture (GBA) to reuse parameters associated with the Global System for Mobile communications (GSM) and/or the Universal Mobile Telecommunication Service (UMTS). For example, the GSM and/or UMTS parameters may be used to derive a root key (or registration key), which is then used to form a service key in the carrier broadcast network layer. The service key may then be used to protect the content keys when they are transmitted over the carrier mobile network.

However, not all networks and/or mobile units provide a mechanism for deriving the registration keys needed for broadcast/multicast security. For example, mobile units that operate according to CDMA1x implement a 64-bit security scheme called ANSI TIA/EIA-41, which was developed by the Telecommunication Industry Association (TIA), the Electronics Industry Association (EIA), and others. The TIA/EIA-41 security scheme provides mutual authentication between a home authentication center (e.g., a Home Location Register/Authentication Center, HLR/AuC) and a user identity module (UIM), such as a removable user identity module (R-UIM), which is typically a card that can be inserted into a mobile shell, or an integrated UIM.

In the TIA/EIA-41 security scheme, a private key, such as a 64-bit random secret known as the A-KEY, is pre-provisioned to a well-protected database in the HLR/AuC and the R-UIM. The private key may be used to secure the wireless link between the HLR/AuC and the R-UIM. For example, the private key may be used to generate a temporary secondary key (known as the shared secret data, SSD, key). The system may then initiate a global challenge authentication by providing a random number (RAND) to the R-UIM, which computes a short digital signature:

AUTHR=ƒ(RAND, SSD_A, ESN, AUTH_DATA),

where ƒ( ) is a standardized function called CAVE, SSD_A is a selected portion of the SSD key, ESN is the electronic serial number associated with the R-UIM, and AUTH_DATA is populated based on the mobile unit's mobile identification number (MIN). The R-UIM provides the AUTHR digital signature to the system (e.g., the HLR/AuC), which may validate the R-UIM based on the AUTHR digital signature. The R-UIM and the HLR/AuC may also compute additional keys, such as a 64-bit signaling message key (SMEKEY) and a 520-bit voice privacy mask (VPM), which may be used as a seed to generate a private long code mask (PLCM), as opposed to the public long code mask that may be generated from the publicly known electronic serial number (ESN) of the mobile.

The TIA/EIA-41 security scheme does not provide a mechanism to generate the registration keys used in the broadcast/multicast security schemes described above. Thus, mobile units that operate according to the CDMA1x protocol, or other protocols that implement security schemes like the TIA/EIA-41 security scheme, cannot generate the temporary keys that are used to protect the broadcast access keys that are transmitted to the mobile unit. Consequently, the mobile units cannot generate session keys that are used to encrypt and decrypt the content keys issued by third-party multimedia content providers. Without a secure mechanism for transmitting content keys to authorized users, multimedia content providers are left with two undesirable choices: providing insecure multimedia content that may be accessed by unauthorized (e.g., non-paying) users and/or losing potential revenue by not providing multimedia content to mobile units that operate according to the CDMA1x protocol.

### SUMMARY OF THE INVENTION

The present invention is directed to addressing the effects of one or more of the problems set forth above. The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

In one embodiment of the present invention, a method is provided involving a mobile shell, a user identity module communicatively coupled to the mobile shell, a home location register, and a broadcast/multicast controller. One embodiment of the method may be implemented in the home location register and includes receiving, at the home location register, a first random number provided by the broadcast/multicast controller and forming, at the home location register, a registration key based on the first random number. The registration key is derivable by the user identity module based on a second random number derived from the first random number. The method also includes providing the registration key to the broadcast/multicast controller.

In another embodiment of the present invention, a method is provided involving a mobile shell, a user identity module communicatively coupled to the mobile shell, a home location register, and a broadcast/multicast controller. One embodiment of the method may be implemented in the broadcast/multicast controller and includes providing, to the home location register, a first random number determined by the broadcast/multicast controller. The method also includes receiving, from the home location register, a registration key based on the first random number. The registration key is derivable by the removable user identity module based on a second random number derived from the first random number. The method further includes providing information indicative of a broadcast access key to the mobile shell. The information indicative of the broadcast access key is encrypted using a temporary key derived from the registration key and the first random number.

In yet another embodiment of the present invention, a method is provided involving a mobile shell, a user identity module communicatively coupled to the mobile shell, a home location register, and a broadcast/multicast controller. One embodiment of the method may be implemented in the mobile shell and includes receiving, from the broadcast/multicast controller, information indicative of a first random number and providing, to the user identity module, a second random number derived from the first random number. The method also includes receiving, from the user identity module, information indicative of a registration key. The information is formed based on the second random number and a pre-provisioned security key known only to the removable user identity module and the home location register.

### BRIEF DESCRIPTION OF THE DRAWINGS

The invention may be understood by reference to the following description taken in conjunction with the accompanying drawings, in which like reference numerals identify like elements, and in which:

FIG. 1 conceptually illustrates one exemplary embodiment of a wireless communication system, in accordance with the present invention;

FIG. 2 conceptually illustrates one exemplary embodiment of a method of generating security keys, in accordance with the present invention; and

FIGS. 3A and 3B conceptually illustrates exemplary embodiments of providing content keys and encrypted content, in accordance with the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

The present invention will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

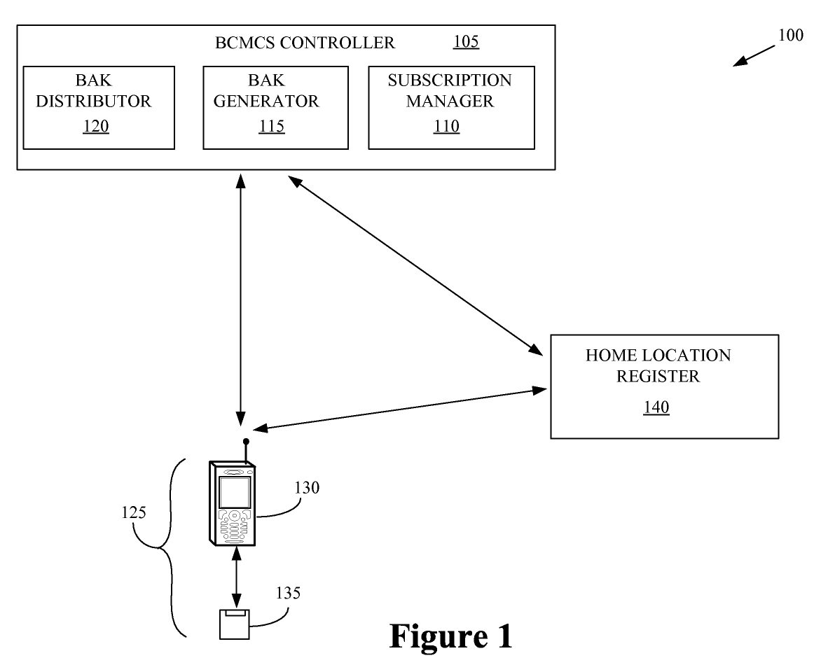

FIG. 1 conceptually illustrates one exemplary embodiment of a wireless communication system 100. In the illustrated embodiment, the wireless communication system 100 includes a broadcast/multicast service controller 105 that implements functionality that may be used to control and/or coordinate broadcast and/or multicast services. The wireless communication system 100 and the broadcast/multicast controller 105 may operate according to a version of the Code Division Multiple Access (CDMA1x) protocol as defined by the Third Generation Partnership Project (3GPP2). This protocol is known to persons of ordinary skill in the art and in the interest of clarity only those aspects of this protocol that are relevant to the present invention will be discussed herein. Furthermore, persons of ordinary skill in the art having benefit of the present disclosure will appreciate that the present invention is not limited to wireless communication systems 100 that operate according to CDMA1x.

In the illustrated embodiment, the broadcast/multicast controller 105 includes a subscription manager 110 that may be used to manage subscriptions for broadcast and/or multicast services that may be provided by the wireless communication system 100. For example, the subscription manager 110 may be used to generate random numbers that may be used for authentication and/or generation of security keys, as will be discussed in detail below. The broadcast/multicast controller 105 also includes a broadcast access key (BAK) generator 115 for generating one or more broadcast access keys that may be used to generate session keys for encrypting data that is broadcast or multicast by the broadcast/multicast controller 105. For example, the broadcast access keys may be stored and/or distributed by a broadcast access key distributor 120 that is implemented in the broadcast/multicast controller 105. The subscription manager 110, BAK generator 115, and/or the BAK distributor 120 may be implemented in hardware, firmware, software, or any combination thereof Furthermore, although the broadcast/multicast controller 105 is depicted as a single functional element including the subscription manager 110, BAK generator 115, and/or the BAK distributor 120, persons of ordinary skill in the art having benefit of the present disclosure should appreciate that the broadcast/multicast controller 105, as well as any portions thereof, may be implemented in any desirable number of functional elements.

The wireless communications system 100 may provide wireless connectivity to one or more mobile units 125. The mobile unit 125 may be any type of mobile unit including, but not limited to, a cellular telephone, a personal data assistant, a smart phone, a text messaging device, a pager, a network interface card, a laptop computer, and a desktop computer. However, persons of ordinary skill in the art having benefit of the present disclosure should appreciate that the present invention is not limited to these particular examples of mobile units 125 and in alternative embodiments other types of mobile units 125 may also be used. Persons of ordinary skill in the art should also appreciate that the mobile units 125 may be referred to using other terms such as subscriber terminal, subscriber station, user equipment, user terminal, access terminal, and the like.

The mobile unit 125 shown in FIG. 1 includes a mobile shell 130 and a user identity module 135. For example, a user may purchase a mobile shell 130 and a user identity module 135 from different vendors. However, persons of ordinary skill in the art having benefit of the present disclosure will appreciate that the present invention is not limited to mobile units 125 that includes separate mobile shells 130 and user identity modules 135. For example, in one alternative embodiment, the mobile shell 130 and the user identity module 135 may be incorporated into an integrated mobile units 125, e.g., users may simply purchase an integrated mobile unit 125 that already includes the mobile shell 130 and the user identity module 135.

The user identity module 135 may include information indicative of the user, as well as information that may be used to verify the user's identity to the wireless communications system 100. In the illustrated embodiment, the user identity modules 135 are removable user identity modules (R-UIMs) 135 that operate according to second-generation wireless telecommunications standards such as the TIA/EIA-41 standard and ANSI TIA/EIA/IS-2000 standard. The user identity module 135 may include one or more keys that are used to establish a security association with the wireless communications system 100. For example, the user identity modules 135 may each include a pre-provisioned 64-bit random number known as an A-KEY. Accordingly, the user identity modules 135 may support the 2 G authentication contents specified in ANSI TIA/EIA/IS-2000 and ANSI TIA/EIA-41, may be able to process 2 G authentication requests, and may be able to generate 2 G session keys, such as the SMEKEY and the Private Long Code Mask (PLCM).

A wireless communication system 100 also includes a home location register 140. Persons of ordinary skill in the art will appreciate that techniques for implementing, maintaining, and/or operating the home location register 140 are known in the art and in the interest of clarity only those aspects of implementing, maintaining, and/or operating a home location register 140 that are relevant to the present invention will be discussed herein. The home location register 140 maintains a database of information associated with mobile units, such as the mobile unit 125, which may be operating, or may be expected to operate, within a wireless communication system 100. In one embodiment, the home location register 140 includes copies of one or more security keys associated with the mobile unit 125, such as a copy of a pre-provisioned 64-bit random number known as an A-KEY. Security keys such as the A-KEY are known only to the home location register 140 and the corresponding user identity module 135 in the mobile unit 125. Consequently, security keys such as the A-KEY that are known only to user identity modules 135 in the individual mobile units 125 and the home location register 140 may be used for authentication and security of communication within the wireless communication system 100.

Mobile units 125 that subscribe to one or more services provided by the broadcast/multicast controller 105 may use a broadcast access key to provide secure transmission between the broadcast/multicast controller 105 and the mobile unit 125. For example, a broadcast/multicast controller 105 may provide a broadcast access key to the mobile unit 125 and the broadcast/multicast controller 105 and the mobile unit 125 may use the broadcast access key to generate a session key for encrypting and decrypting information that is broadcast and/or multicast to the mobile unit 125. In order to reduce the likelihood that the broadcast access key may be intercepted by an attacker and used to fraudulently obtain broadcast and/or multicast services, particularly services provided by third parties that operate independently of the bar/multicast controller 105, the broadcast access keys may be encrypted using security keys derived from the security keys (such as the A-KEY) known only to the mobile unit's user identity module 135 and the home location register 140. The session key generated from broadcast access keys may then be used to encrypt content keys that may be used to secure content provided by third parties to authorize mobile units 125.

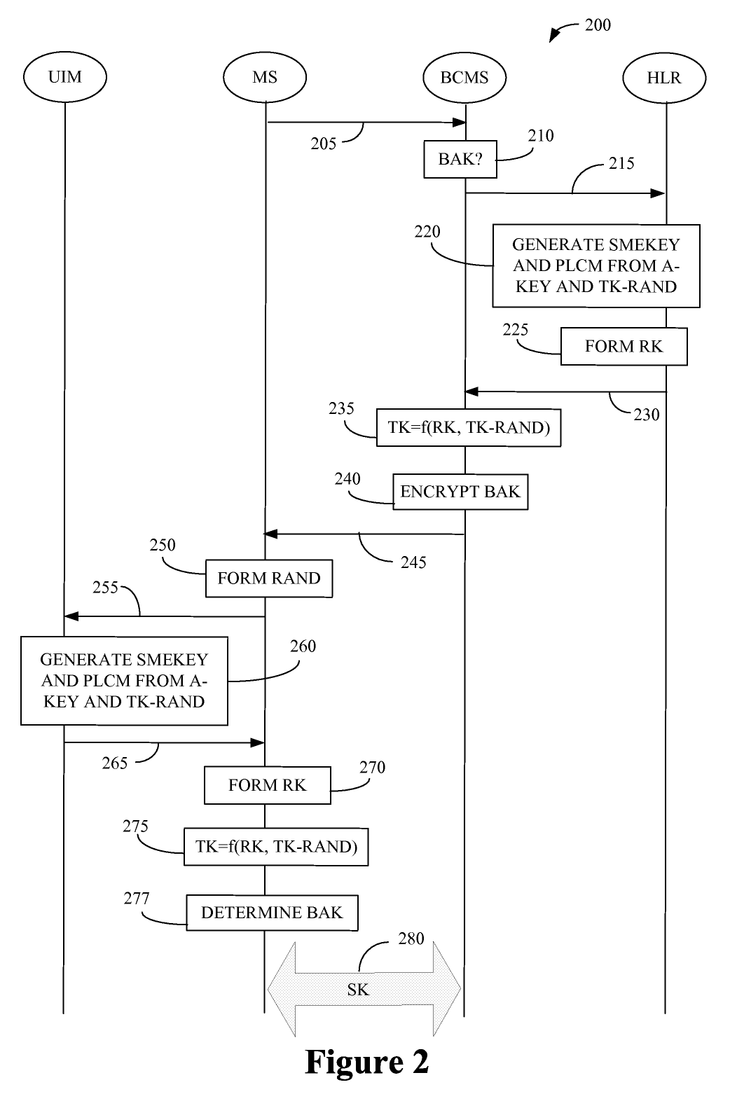

FIG. 2 conceptually illustrates one exemplary embodiment of a method 200 of generating security keys. In the illustrated embodiment, a mobile shell (MS) provides a request to a broadcast/multicast server (BCMS) to get a broadcast access key for future secure communications, as indicated by the arrow 205. The broadcast/multicast server that determines (at 210) whether or not a broadcast access key exists for the mobile shell. For example, the mobile shell may provide the request to the BAK distribution function in the broadcast/multicast server and the BAK distribution function made search a residence database to determine whether or not a broadcast access key exists for the mobile shell. If one does exist, then it may be provided to the mobile shell, as will be discussed in more detail below. However, if the broadcast/multicast server determines (at 210) that no broadcast access key exists for the mobile shell, then the broadcast/multicast server generates a new broadcast access key. For example, the BAK generator function in the broadcast/multicast server may generate the new broadcast access key.

The broadcast/multicast server then provides a request (indicated by the arrow 215) to a home location register (HLR) for a temporary security key that may be used to encrypt the broadcast access key for transmission to the mobile shell. In one embodiment, a subscription manager in the broadcast/multicast server generates a random number (TK-RAND) that is transmitted to the home location register with the request for the temporary security key.

The home location register generates (at 220) key material using the provided random number and the security key known only to the home location register and a corresponding mobile unit. In the illustrated embodiment, the home location register truncates the provided random number to a 32-bit random number and then generates (at 220) a security key (SMEKEY) and a public long code mask by applying the known CAVE algorithm to the A-KEY and the 32-bit random number. The SMEKEY and the public long code mask are concatenated and padded with one or more zeros to form (at 225) a 128-bit registration key. The registration key is then provided to the broadcast/multicast server using the mutually authenticated communication channel, as indicated by the arrow 230. The broadcast/multicast server may then use the provided registration key and the random number (TK-RAND) to generate (at 235) one or more temporary keys using known cryptographic functions. The temporary key may then be used to encrypt (at 240) the broadcast access key. For example, the BAK distributor may be configured to generate (at 235) the temporary keys and to encrypt (at 240) the broadcast access key for transmission to the mobile shell.

Encrypted information indicative of the broadcast access key and the random number (TK-RAND) used to form the temporary key is provided to the mobile shell, as indicated by the arrow 245. The mobile shell may then extract the provided random number and truncate this number to form (at 250) another random number (RAND), which may be a 32-bit random number. The truncated random number is provided to the user identity module associated with the mobile shell, as indicated by the arrow 255. In one embodiment, the truncated random number may be used to mutually authenticate the mobile shell and the user identity module. The user identity module generates (at 260) key material using the provided random number and the security key known only to the user identity module in the mobile unit. In the illustrated embodiment, the user identity module generates (at 260) a security key (SMEKEY) and a public long code mask by applying the known CAVE algorithm to the A-KEY and the 32-bit random number provided by the mobile shell. The SMEKEY and the public long code mask are provided to the mobile shell, as indicated by the arrow 265, and the mobile shell concatenates the SMEKEY and the public long code mask and pads the concatenation with one or more zeros to form (at 270) a 128-bit registration key, which should correspond to the 128 bit registration key that is known to the broadcast/multicast server.

The mobile shell may then use the provided registration key and the random number (TK-RAND) to generate (at 275) a temporary key, which may be used to decrypt the encrypted BAK message that was provided at 245. The mobile shell may then determine (at 277) the BAK. In one embodiment, the BAK is derived using the temporary key. Alternatively, the BAK may be determined (at 277) by decrypting the BAK message using the temporary key. The BAK is then used to generate one or more session keys (SK) using known cryptographic functions. The broadcast/multicast server may also generate session keys using its copy of the BAK. Since the temporary keys generated by the mobile shell and the broadcast/multicast server should match, the broadcast access keys BAK generated by the mobile shell and the broadcast/multicast server should also match and session keys generated from BAK should match, too, which may permit secure communication between the mobile station and the broadcast/multicast server, as indicated by the double-arrow 280. The secure communication channel 280 may then be used to provide content keys to the mobile shell by encrypting the content keys using the associated session keys. The content keys may be used to encrypt the content provided by third party broadcast and/or multicast service providers.

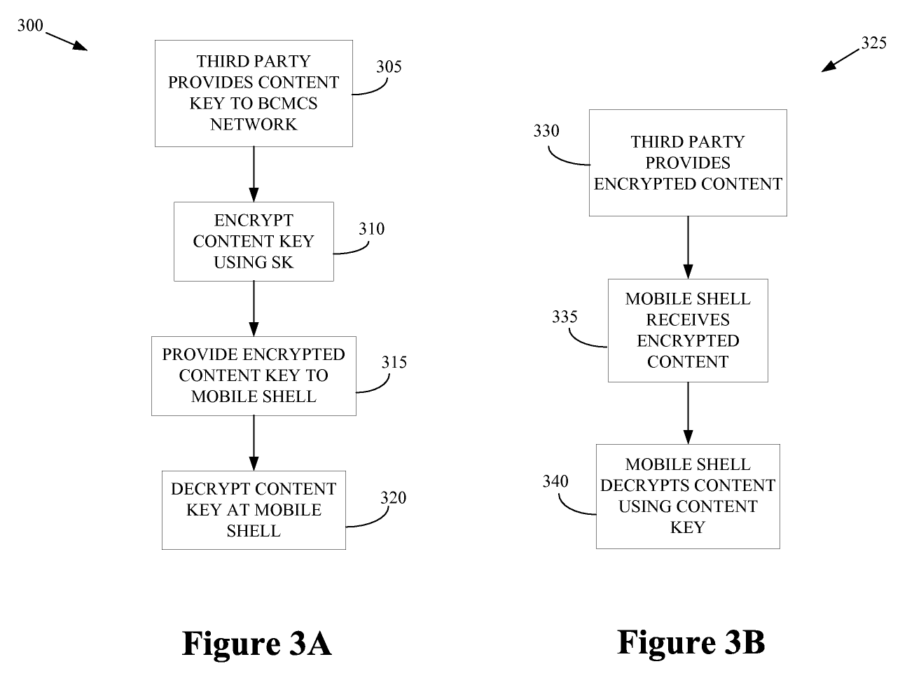

FIG. 3A conceptually illustrates one exemplary embodiment of a method 300 for providing content keys. In the illustrated embodiment, a third-party broadcast or multicast service provider generates and provides (at 305) a content key to a broadcast/multicast provider network. A controller in the broadcast/multicast provider network encrypts (at 310) the provided content key using a session key derived from key material known only to a home location register and the mobile unit(s) that have subscribed to the broadcast or multicast services, as discussed above. The encrypted content key is then provided (at 315) to the mobile shell, which may decrypt (at 320) the content key using a copy of the session key derived from the key material known only to the home location register and the mobile unit. The decrypted content keys may be then be used to provide secure broadcasting and/or multicasting to authorize mobile units.

FIG. 3B conceptually illustrates one exemplary embodiment of a method 325 for providing encrypted content. In the illustrated embodiment, the third party generates broadcast and/or multicast content and then encrypts (at 330) this content using a copy of the content key or keys that have been provided to the mobile unit. The encrypted information is provided to the mobile shell, which receives (at 335) the encrypted content. The mobile shell may then decrypt (at 340) the provided content using the content key. Since only mobile shells that possess the correct content key can decrypt the provided content, unauthorized mobile shells may not decrypt the broadcast and/or multicast content. In one embodiment, the content keys may be provided using one network (e.g., broadcast/multicast service provider or mobile operator network) and the encrypted content may be provided using a different network (e.g., a third party content provider network).

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope of the invention. Accordingly, the protection sought herein is as set forth in the claims below.

What is claimed:

1. A method involving a mobile shell, a removable user identity module communicatively coupled to the mobile shell, a home location register, and a broadcast/multicast controller, comprising:
receiving, at the home location register, a first random number provided by the broadcast/multicast controller;
forming, at the home location register, a registration key based on the first random number, the registration key being derivable by the user identity module based on a second random number derived from the first random number; and
providing the registration key to the broadcast/multicast controller.

2. The method of claim 1, wherein forming the registration key comprises forming the registration key based on a pre-provisioned key known only to the removable user identity module and the home location register.

3. The method of claim 2, wherein forming the registration key comprises truncating the first random number to a selected number of bits corresponding to the second random number.

4. The method of claim 3, wherein forming the registration key comprises generating a SMEKEY and a public long code mask based on the truncated first random number and the pre-provisioned key.

5. The method of claim 4, wherein forming the registration key comprises concatenating the SMEKEY, the public long code mask, and at least one padding bit.

6. The method of claim 1, wherein providing the registration key to the broadcast/multicast controller comprises providing the registration key via a secure communication channel associated with the broadcast/multicast controller and home location register.

7. A method involving a mobile shell, a removable user identity module communicatively coupled to the mobile shell, a home location register, and a broadcast/multicast controller, comprising:
providing, to the home location register, a first random number determined by the broadcast/multicast controller;
receiving, from the home location register, a registration key based on the first random number, the registration key being derivable by the removable user identity module based on a second random number derived from the first random number; and
providing information indicative of a broadcast access key to the mobile shell, the information indicative of the broadcast access key being encrypted using a temporary key derived from the registration key and the first random number.

8. The method of claim 7, wherein receiving the registration key from the home location register comprises receiving the registration key via a secure communication channel associated with the broadcast/multicast controller and home location register.

9. The method of claim 7, wherein receiving the registration key comprises receiving information indicative of a SMEKEY and a public long code mask formed based on a pre-provisioned security key known only to the removable user identity module and the home location register.

10. The method of claim 7, comprising forming the temporary key based on the registration key and the first random number.

11. The method of claim 10, comprising generating the broadcast access key and encrypting information indicative of the broadcast access key using the temporary key and the first random number.

12. The method of claim 7, comprising forming at least one session key based on the broadcast access key.

13. The method of claim 12, comprising encrypting information indicative of a content key using the session key.

14. The method of claim 13, wherein encrypting information indicative of the content key comprises encrypting information indicative of a content key provided by a third party, the content key being used to encrypt broadcast/multicast content provided by the third party.

15. The method of claim 14, comprising providing the encrypted information indicative of the content key to the mobile shell.

16. A method involving a mobile shell, a removable user identity module communicatively coupled to the mobile shell, a home location register, and a broadcast/multicast controller, comprising:
receiving, from the broadcast/multicast controller, information indicative of a first random number;
providing, to the user identity module, a second random number derived from the first random number; and
receiving, from the user identity module, information indicative of a registration key, the information being formed based on the second random number and a pre-provisioned security key known only to the removable user identity module and the home location register.

17. The method of claim 16, wherein providing the second random number comprises truncating the first random number to a selected number of bits and providing the truncated the first random number to the removable user identity module.

18. The method of claim 16, wherein receiving the information indicative of the registration key comprises receiving information indicative of a SMEKEY and a public long code mask formed based on the pre-provisioned security key known only to the removable user identity module and the home location register.

19. The method of claim 16, comprising:
receiving, from the broadcast/multicast controller, information indicative of a broadcast access key, the information being encrypted based on a temporary key and the first random number;
forming the registration key based on the information indicative of the registration key;
deriving a temporary key using the registration key and the first random number; and
determining the broadcast access key using the temporary key and the information indicative of the broadcast access key.

20. The method of claim 19, comprising forming at least one session key based on the broadcast access key.

21. The method of claim 20, comprising receiving encrypted information indicative of a content key and decrypting the information indicative of the content key using said at least one session key.

22. The method of claim 21, wherein receiving the encrypted information indicative of the content key comprises receiving encrypted information indicative of a content key provided by a third party, the content key being used to encrypt broadcast/multicast content provided by the third party.

23. The method of claim 22, comprising receiving and decrypting broadcast/multicast content provided by the third party using the content key.

24. The method of claim 23, wherein receiving the encrypted information indicative of the content key comprises receiving the encrypted information indicative of the content key via a first network and receiving the broadcast/multimedia content comprises receiving broadcast/multimedia content provided by the third party via a second network.
